(19) United States
(12) Patent Application Publication
(10) Pub. No.: US 2026/0194835 A1
(43) Pub. Date: Jul. 9, 2026

(54) TONER, METHOD OF PRODUCING TONER, AND IMAGE FORMING METHOD USING TONER

(71) Applicant: Konica Minolta, Inc., Tokyo (JP)

(72) Inventors: Junya UEDA, Tokyo (JP); Shiori TSUDA, Tokyo (JP)

(21) Appl. No.: 19/439,897

(22) Filed: Jan. 5, 2026

(30) Foreign Application Priority Data
Jan. 9, 2025 (JP) 2025-003286

(51) Int. Cl. G03G 9/087

(52) U.S. Cl. CPC G03G 9/08755; G03G 9/08711

(57) ABSTRACT

Provided is toner containing a binding resin and a mold release agent. The binding resin contains a vinyl resin and an amorphous polyester resin, an amount of the amorphous polyester resin is equal to or greater than 20% by mass with respect to a total mass of the binding resin and the mold release agent, an amount of the mold release agent is equal to or greater than 5% by mass with respect to the total mass of the binding resin and the mold release agent, the mold release agent is encapsulated in the vinyl resin, and the amount of the mold release agent is equal to or less than 40% by mass with respect to a total mass of the vinyl resin and the mold release agent.

### CROSS REFERENCE TO RELATED APPLICATIONS

The entire disclosure of Japanese Patent Application No. 2025-003286, filed on Jan. 9, 2025, is incorporated herein by reference in its entirety.

### BACKGROUND

### Technological Field

The present invention relates to toner, a method of producing the toner, and an image forming method using the toner.

### Description of Related Art

It is known that toner contains toner base particles, and the toner base particles contain a binding resin and a mold release agent. For example, Japanese Patent Application Laid-Open No. 2019-203964 discloses toner base particles containing a binding resin and a mold release agent.

### SUMMARY

The toner as described above contains a polyester resin as the binding resin. From the viewpoint of improving the low-temperature fixability of the toner, the amount of the polyester resin is preferably large. On the other hand, the toner base particles also contain a mold release agent (wax) for improving the separability between a fixing member for fixing an image and the image in an image forming apparatus. Here, it is considered that when the toner base particles contain a large amount of the polyester resin, a mold release agent having a low polarity is present in a large size in the toner base particles. When an image is formed with toner containing such toner base particles, it is considered that a mold release agent having a large size is present on the surface of the image at the time of fixing the toner. The mold release agent present in a large size on the surface of an image is likely to repel varnish when the varnish is applied to the surface of the image. Thus, it is considered that the adhesion of the varnish to the image deteriorates.

An object of the present invention is to provide toner capable of improving adhesion of varnish to an image while improving the separability of the image. Another object of the present invention is to provide a method of producing the toner. Yet another object of the present invention is to provide an image forming method using the toner.

In order to achieve at least one of the objects described above, toner reflecting one aspect of the present invention is toner containing a binding resin and a mold release agent. The binding resin contains a vinyl resin and an amorphous polyester resin, an amount of the amorphous polyester resin is equal to or greater than 20% by mass with respect to a total mass of the binding resin and the mold release agent, an amount of the mold release agent is equal to or greater than 5% by mass with respect to the total mass of the binding resin and the mold release agent, the mold release agent is encapsulated in the vinyl resin, and the amount of the mold release agent is equal to or less than 40% by mass with respect to a total mass of the vinyl resin and the mold release agent.

### DETAILED DESCRIPTION OF EMBODIMENTS

Hereinafter, one or more embodiments of the present invention will be described. However, the scope of the invention is not limited to the disclosed embodiments.

Hereinafter, a preferred embodiment of the present invention will be described.

The reason why the above-described problems are solved by the toner according to the embodiment of the present invention is presumed as follows.

In the toner according to the embodiment of the present invention, the mold release agent is at least partially encapsulated in the vinyl resin. The vinyl resin is a binding resin in the same manner as the polyester resin. It is considered that the mold release agent present in the vinyl resin is present in a finely dispersed state. In addition, when the amorphous polyester is present in an amount equal to or greater than 20% by mass under instantaneous heating for fixing, the mold release agents do not coalesce with each other, and can be smeared on the surface of the image while maintaining the finely dispersed state. For this reason, when the varnish is applied to the image, the varnish is less likely to be repelled by the mold release agent and is likely to come into contact with the resin. Thus, it is considered that the adhesion of the varnish to the image improves. Further, it is considered that when the amount of the mold release agent is equal to or greater than 5% by mass with respect to the total mass of the binding resin and the mold release agent, the separability of the image also improves.

Note that, the “toner” is toner for electrostatic latent image development. The toner contains toner base particles. The toner base particles may also be contained, as toner particles with an external additive on their surfaces, in the toner. The “toner image” refers to a state in which toner is aggregated in an image shape.

### [Configuration of Toner]

Hereinafter, the configuration of the toner base particles contained in the toner will be described.

### <Toner Base Particles>

The toner base particles contain at least a binding resin and a mold release agent, and may further contain any other constituent component such as a coloring agent and a charge control agent, if necessary.

### (Binding Resin)

The binding resin binds the toner to a recording medium.

Examples of the type of the binding resin include a vinyl resin and a polyester resin. Examples of the type of the polyester resin include an amorphous polyester resin and a crystalline polyester resin.

The constituent ratio (% by mass) of the vinyl resin to the polyester resin in the binding resin is preferably within a range of vinyl resin: polyester resin=80:20 to 1:99, and more preferably within a range of 60:40 to 5:95. The vinyl resin is preferably a styrene-acrylic resin.

The amorphous polyester resin is a resin that does not exhibit a definite endothermic peak when subjected to differential scanning calorimetry (DSC). On the other hand, the crystalline resin is a resin that exhibits a definite endothermic peak when subjected to differential scanning calorimetry (DSC).

### <<Vinyl Resin>>

The vinyl resin is preferably a styrene-acrylic resin.

Examples of a styrene-based monomer and a (meth)acrylic acid ester-based monomer for producing the styrene-acrylic resin include the following monomers which can be used either alone or in combination of two or more thereof. In addition, (meth)acrylic acid can also be used.

### (1) Styrene-Based Monomer

Examples of the styrene-based monomer includes styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and monomers having a styrene structure such as derivatives thereof.

Inter alia, styrene is preferable.

### (2) (Meth)acrylic Acid Ester-Based Monomer

Examples of the (meth)acrylate ester-based monomer include methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth) acrylate, phenyl (meth)acrylate, diethylaminoethyl (meth)acrylate, dimethylaminoethyl (meth) acrylate, and monomers having a (meth)acrylic group such as derivatives thereof.

Inter alia, methacrylic acid and n-butyl acrylate are preferable.

The mass percentage of the vinyl resin with respect to the total mass of the binding resin and the mold release agent may be equal to or greater than 20% by mass, equal to or greater than 25% by mass, or equal to or greater than 30% by mass. The mass percentage of the vinyl resin with respect to the total mass of the binding resin and the mold release agent may be equal to or less than 50% by mass, equal to or less than 40% by mass, or equal to or less than 30% by mass.

### <<Polyester Resin>>

Examples of the type of the polyester resin include an amorphous polyester resin and a crystalline polyester resin.

### <<Amorphous Polyester Resin>>

The amorphous polyester resin is a resin exhibiting an amorphous property among polyesters obtained through a polymerization reaction of a di- or higher-valent carboxylic acid (polyvalent carboxylic acid) monomer and a di- or higher-valent alcohol (polyhydric alcohol) monomer. The amorphous polyester resin can be formed by polymerizing (esterifying) the polyvalent carboxylic acid monomer and the polyhydric alcohol monomer by utilizing an esterification catalyst known in the art.

The polyvalent carboxylic acid monomer is a compound having two or more carboxy groups in one molecule. Examples of the polyvalent carboxylic acid that can be used for synthesis of the amorphous polyester include phthalic acid, isophthalic acid, terephthalic acid, trimellitic acid, naphthalene-2,6-dicarboxylic acids, malonic acid, mesaconic acid, dimethyl isophthalate, fumaric acid, dodecenyl succinic acid and 1,10-dodecanedicarboxylic acid. Among these, dimethyl isophthalate, terephthalic acid, dodecenylsuccinic acid, and trimellitic acid are preferable.

The polyhydric alcohol monomer is a compound having two or more hydroxy groups in one molecule.

Examples of a polyhydric alcohol monomer that can be used for synthesis of the amorphous polyester include, as dihydric or trihydric alcohols, ethylene glycol, propylene glycol, 1,4-butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, ethylene oxide adduct of bisphenol A (BPA-EO), propylene oxide adduct of bisphenol A (BPA-PO), glycerin, sorbitol, 1,4-sorbitan, and trimethylolpropane. Among these, an ethylene oxide adduct of bisphenol A and a propylene oxide adduct of bisphenol A are preferable.

Examples of usable esterification catalysts include compounds of alkali metals such as sodium and lithium; compounds of alkaline earth metals such as magnesium and calcium; compounds of metals such as aluminum, zinc, manganese, antimony, titanium, tin, zirconium, and germanium; phosphorous acid compounds; phosphoric acid compounds; and amine compounds.

The polymerization temperature is not particularly limited, but is preferably 150° C. to 250° C. In addition, the polymerization time is not particularly limited, but is preferably 0.5 hours to ten hours. During the polymerization, the pressure in the reaction system may be reduced as necessary.

The mass percentage of the amorphous polyester resin with respect to the total mass of the binding resin and the mold release agent may be equal to or greater than 20% by mass, equal to or greater than 25% by mass, equal to or greater than 30% by mass, equal to or greater than 35% by mass, or equal to or greater than 40% by mass from the viewpoint of improving the low-temperature fixability and varnish adhesion. The mass percentage of the amorphous polyester resin with respect to the total mass of the binding resin and the mold release agent may be equal to or less than 60% by mass, equal to or less than 55% by mass, equal to or less than 50% by mass, or equal to or less than 40% by mass.

### <<Crystalline Polyester>>

The crystalline resin is not limited as long as it is a resin exhibiting a crystalline property, and a crystalline resin known in the art can be used. To exhibit a crystalline property means that, in an endothermic curve obtained by DSC, the resin has a melting point, that is, the resin has a definite endothermic peak, instead of a stepwise endothermic change, during temperature increase.

It is preferable to use a crystalline polyester as a crystalline material. The crystalline polyester can also have a function as a binding resin.

The crystalline polyester used in the present invention is obtained by a polycondensation reaction between di- or higher-valent carboxylic acid (polyvalent carboxylic acid) and di- or higher-valent alcohol (polyhydric alcohol).

Examples of the polyvalent carboxylic acid include a dicarboxylic acid. The dicarboxylic acid may be one or more kinds of dicarboxylic acids, is preferably an aliphatic dicarboxylic acid, and may further include an aromatic dicarboxylic acid. The aliphatic dicarboxylic acid is preferably of a straight-chain type from the viewpoint of enhancing the crystalline property of the crystalline polyester.

Examples of the aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic (dodecanedioic) acid, 1,13-tridecanedicarboxylic acid, 1,14-tetradecanedicarboxylic acid, 1,16-hexadecanedicarboxylic acid, 1,18-octadecanedicarboxylic acid, lower alkyl esters thereof, and acid anhydrides thereof. Inter alia, an aliphatic dicarboxylic acid having six or more and 16 or less carbon atoms is preferable, and an aliphatic dicarboxylic acid having ten or more and 14 or less carbon atoms is more preferable, from the viewpoint of easily obtaining the effect of achieving both low-temperature fixability and transferability.

Examples of the aromatic dicarboxylic acid include terephthalic acid, isophthalic acid, orthophthalic acid, t-butylisophthalic acid, 2,6-naphthalenedicarboxylic acid and 4,4′-biphenyldicarboxylic acid. Inter alia, terephthalic acid, isophthalic acid, or t-butylphthalic acid is preferable from the viewpoints of availability and emulsifiability.

The content of the constituent unit derived from the aliphatic dicarboxylic acid with respect to the constituent unit derived from the dicarboxylic acid in the crystalline polyester is preferably equal to or greater than 50 mol %, more preferably equal to or greater than 70 mol %, still more preferably equal to or greater than 80 mol %, and particularly preferably equal to or greater than 100 mol %, from the viewpoint of sufficiently ensuring the crystalline property of the crystalline polyester.

Examples of the polyhydric alcohol component include a diol. The diol may be one or more kinds of diols, is preferably an aliphatic diol, and may further include any other diol. The aliphatic diol is preferably of a straight-chain type from the viewpoint of enhancing the crystalline property of the crystalline polyester.

Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Inter alia, an aliphatic diol having two or more and 12 or less carbon atoms is preferable, and an aliphatic diol having four or more and six or less carbon atoms is more preferable, from the viewpoint of easily obtaining the effect of achieving both low-temperature fixability and transferability.

Examples of the other diol include a diol having a double bond and a diol having a sulfonic acid group. Specific examples of the diol having a double bond include 2-butene-1,4-diol, 3-butene-1,6-diol, and 4-butene-1,8-diol.

The crystalline polyester can be synthesized by polycondensation (esterification) of the polyvalent carboxylic acid and the polyhydric alcohol by utilizing an esterification catalyst known in the art.

The catalyst that can be used in the synthesis of the crystalline polyester may be one or more kinds of catalysts, and examples thereof include compounds of alkali metals such as sodium and lithium;

compounds containing a Group 2 element such as magnesium and calcium; compounds of metals such as aluminum, zinc, manganese, antimony, titanium, tin, zirconium, and germanium; phosphorous acid compounds; phosphoric acid compounds; and amine compounds.

Specifically, examples of the tin compound include dibutyltin oxide, tin octylate, tin dioctylate, and salts thereof. Examples of the titanium compound include titanium alkoxides such as tetra-n-butyl titanate, tetraisopropyl titanate, tetramethyl titanate, and tetrastearyl titanate; titanium acylates such as polyhydroxy titanium stearate; and titanium chelates such as titanium tetraacetylacetonate, titanium lactate, and titanium triethanolaminate. Examples of the germanium compound include germanium dioxide, and examples of the aluminum compound include an oxide such as polyaluminum hydroxide, an aluminum alkoxide, and tributyl aluminate.

The toner preferably contains a crystalline polyester resin from the viewpoint of improving low-temperature fixability. The mass percentage of the crystalline polyester resin with respect to the total mass of the binding resin and the mold release agent may be equal to or more than 5% by mass, equal to or more than 8% by mass, or equal to or more than 10% by mass, from the viewpoint of improving low-temperature fixability. The mass percentage of the crystalline polyester resin with respect to the total mass of the binding resin and the mold release agent may be equal to or less than 15% by mass, or equal to or less than 12% by mass.

### (Coloring Agent)

The toner base particles may contain a coloring agent. As the coloring agent, a coloring agent known in the art can be used.

Specifically, examples of the coloring agent contained in the yellow toner include C.I. Solvent Yellows 19, 44, 77, 79, 81, 82, 93, 98, 103, 104, 112, and 162, and C.I. Pigment Yellows 14, 17, 74, 93, 94, 138, 155, 180, and 185. These coloring agents may be used alone or in combination of two or more thereof.

Examples of the coloring agent contained in the magenta toner include C.I. Solvent Reds 1, 49, 52, 58, 63, 111, and 122, and C.I. Pigment Reds 5, 48:1, 53:1, 57:1, 122, 139, 144, 149, 166, 177, 178, and 222. These coloring agents may be used alone or in combination of two or more thereof.

Examples of the coloring agent contained in the cyan toner include C.I. Pigment Blue 15:3.

Examples of the coloring agent contained in the black toner include carbon black, a magnetic material, and titanium black. Examples of the carbon black include channel black, furnace black, acetylene black, thermal black, and lamp black. Examples of the magnetic material include ferromagnetic metals such as iron, nickel, and cobalt; alloys containing these ferromagnetic metals; compounds of ferromagnetic metals such as ferrite and ferromagnetic; and alloys containing no ferromagnetic metal but exhibiting ferromagnetism by heat treatment. Examples of the alloy that exhibits ferromagnetism by heat treatment include Heusler alloys such as manganese-copper-aluminum and manganese-copper-tin; and chromium dioxide.

The content of the coloring agent is preferably 1 part by mass to 10 parts by mass, and more preferably 2 parts by mass to 9 parts by mass, with respect to 100 parts by mass of the binding resin.

### (Mold Release Agent)

As the mold release agent, various waxes known in the art can be used. The mold release agent is encapsulated in the vinyl resin.

Examples of the waxes include polyolefin waxes such as polyethylene wax and polypropylene wax; branched chain hydrocarbon waxes such as microcrystalline wax; long-chain hydrocarbon-based waxes such as paraffin wax and Sasol wax; dialkyl ketone-based waxes such as distearyl ketone; ester waxes such as carnauba wax, montan wax, behenic acid behenate, trimethylolpropane tribehenate, pentaerythritol tetrabehenate, pentaerythritol diacetate dibehenate, glycerin tribehenate, 1,18-octadecanediol distearate, trimellitic acid tristearyl, and distearyl maleate; and amide waxes such as ethylenediamine behenylamide, trimellitic acid tristearylamide. In addition, these mold release agents may be used alone or in combination of two or more thereof.

The amount of the mold release agent may be equal to or greater than 5% by mass or equal to or greater than 10% by mass with respect to the total mass of the binding resin and the mold release agent from the viewpoint of improving the separability. On the other hand, the amount of the mold release agent may be equal to or less than 40% by mass, equal to or less than 30% by mass, equal to or less than 20% by mass, or equal to or less than 15% by mass with respect to the total mass of the binding resin and the mold release agent from the viewpoint of improving the varnish adhesion and varnish applicability.

The amount of the mold release agent may be equal to or less than 40% by mass or equal to or less than 30% by mass with respect to the total mass of the vinyl resin and the mold release agent from the viewpoint of improving the varnish adhesion. On the other hand, the amount of the mold release agent may be equal to or greater than 20% by mass, equal to or greater than 30% by mass, or equal to or greater than 35% by mass with respect to the total mass of the vinyl resin and the mold release agent from the viewpoint of improving the separability.

### (Charge Control Agent)

Examples of the charge control agent include various compounds known in the art. The content of the charge control agent is preferably in a range of 0.1% by mass to 5.0% by mass with respect to the total mass of the binding resin.

### <External Additive>

As the external additive to be disposed on the surface of the toner base particles, conventional metal oxide particles known in the art can be used for the purpose of controlling the fluidity and the chargeability.

Examples of the external additive include silica particles, titania (titanium oxide) particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles. Among these external additives, silica particles or titania particles are preferable. In addition, these external additives may be used alone or in combination of two or more thereof.

In addition, organic fine particles of a homopolymer of styrene, methyl methacrylate, or the like, a copolymer of these, or the like may be used as the external additive.

The external additive is contained in an amount equal to or less than 0.3% by mass, preferably in a range of 0.1% by mass to 0.2% by mass, with respect to the toner base particles.

### [Method for Producing Toner]

The method of producing the toner according to the present invention is not particularly limited, and a method known in the art can be adopted. Examples thereof include methods known in the art, such as a kneading and pulverizing method, a suspension polymerization method, an emulsion aggregation method, a dissolution suspension method, a polyester elongation method, and a dispersion polymerization method. Among these methods, the emulsion aggregation method is preferably adopted from the viewpoint of the control of the particle diameter inner configuration and the controllability of the shape.

The emulsion aggregation method is a method of producing toner particles by mixing a dispersion of particles of a binding resin (hereinafter, also referred to as “binding resin particles”), which have been dispersed with a surfactant or a dispersion stabilizer, with a dispersion of particles of a coloring agent (hereinafter, also referred to as “coloring agent particles”) as necessary, aggregating the mixture until a desired toner particle diameter is obtained, and further performing fusion between the binding resin particles to control the shape. Here, the particles of the binding resin may optionally contain a charge control agent and the like.

Hereinafter, an example of the method of producing the toner will be described, but the present invention is not limited thereto. In the following example, a method of producing toner containing a styrene-acrylic resin and polyester will be described.
(1) A step of synthesizing a vinyl resin (for example, a styrene-acrylic resin) in the presence of a mold release agent to prepare a dispersion of styrene-acrylic resin particles encapsulating the mold release agent;
(2) a step of synthesizing an amorphous polyester and a crystalline polyester to prepare a dispersion of amorphous polyester particles and a dispersion of crystalline polyester particles;
(3) a step of preparing a dispersion of coloring agent particles;
(4) a step of forming toner base particles by aggregation of the vinyl resin, the amorphous polyester particles, the crystalline polyester resin particles, the mold release agent, and the coloring agent particles;
(5) a step of aging the toner base particles by thermal energy to control the shape of the toner base particles;
(6) a step of cooling a dispersion of the toner base particles;
(7) a step of separating the toner base particles from the aqueous medium by filtration and washing the toner base particles to remove the surfactant and the like therefrom to obtain wet toner base particles;
(8) a step of performing solvent removal for the wet toner base particles;
(9) a step of drying the wet toner base particles with an airflow in a dryer; and
(10) a step of adding an external additive to the dried toner base particles.

Details of the respective steps (1) to (10) will be described below.

### (1) the Step of Synthesizing a Vinyl Resin (for Example, a Styrene-Acrylic Resin) to Prepare a Dispersion of Vinyl Resin Particles

In this step, a vinyl resin is synthesized in the presence of a mold release agent by a conventional method known in the art, and the vinyl resin encapsulating the mold release agent is dispersed in the form of fine particles in an aqueous medium, thereby preparing a dispersion of vinyl resin particles.

Specifically, the mold release agent is encapsulated in the vinyl resin by dissolving or dispersing the mold release agent in a monomer solution for synthesizing the vinyl resin in advance. That is, the mold release agent is internally added to the vinyl resin. In addition, the vinyl resin may be synthesized in the presence of an internal additive such as a charge control agent when needed.

### (2) The Step of Synthesizing an Amorphous Polyester and a Crystalline Polyester to Prepare a Dispersion of Amorphous Polyester Particles and a Dispersion of Crystalline Polyester Particles

In this step, an amorphous polyester (or a crystalline polyester) is synthesized by a conventional method known in the art. The synthesized amorphous polyester (or crystalline polyester) is dispersed in the form of fine particles in an aqueous medium. Thus, a dispersion of amorphous polyester particles and a dispersion of crystalline polyester particles are prepared.

Specifically, an amorphous polyester (or a crystalline polyester) is first dissolved or dispersed in an organic solvent to prepare an oil phase liquid. Then, the oil phase liquid is dispersed in an aqueous medium by phase inversion emulsification or the like to form oil droplets controlled to be in a state of having a desired particle diameter. Thereafter, the organic solvent is removed to prepare an aqueous dispersion of amorphous polyester particles (or an aqueous dispersion of crystalline polyester particles).

The usage amount of the aqueous medium is preferably in a range of 50% by mass to 2000% by mass and more preferably in a range of 100% by mass to 1000% by mass with respect to the total mass of the oil phase liquid.

A surfactant or the like may also be added to the aqueous medium from the viewpoint of the dispersion stability of the oil droplets. Examples of the surfactant include various conventional anionic surfactants, cationic surfactants, and nonionic surfactants known in the art.

From the viewpoint of removal processing after formation of oil droplets, as the organic solvent used in the preparation of the oil phase liquid, those having a low boiling point and low solubility in water are preferable. Specific examples thereof include methyl acetate, ethyl acetate, methyl ethyl ketone, methyl isobutyl ketone, toluene, and xylene. These organic solvents may be used alone or in combination of two or more thereof.

The usage amount of the organic solvent is preferably in a range of 1% by mass to 300% by mass with respect to the total mass of the amorphous polyester (or the crystalline polyester).

The emulsification and dispersion of the oil phase liquid can be performed utilizing mechanical energy.

### (3) the Step of Preparing a Dispersion of Coloring Agent Particles

An aqueous dispersion of coloring agent particles can also be prepared in the same sequence as in the preparation of the aqueous dispersion of mold release agent particles described above. Note that, the mold release agent particles are preferably heated to a temperature equal to or higher than the melting point thereof to be dispersed, but the coloring agent particles are not necessarily heated.

### (4) the Step of Forming Toner Base Particles by Aggregation of the Amorphous Polyester Particles, the Styrene-Acrylic Resin Particles, and the Coloring Agent Particles

In this step, a coagulant is added to the aqueous dispersion having a concentration equal to or more than the critical aggregation concentration, in which the respective fine particles of the particles described above have been dispersed, to aggregate the fine particles to some extent. Then, shape control is performed by performing fusion between the fine particles to form toner base particles.

The coagulant is not particularly limited, but is preferably, for example, a metal salt such as an alkali metal salt or an alkaline earth metal salt. Examples of the metal salt include salts of monovalent metals such as sodium, potassium, and lithium; salts of divalent metals such as calcium, magnesium, manganese, and copper; and salts of trivalent metals such as iron and aluminum.

Specific examples of the metal salt include sodium chloride, potassium chloride, lithium chloride, calcium chloride, magnesium chloride, zinc chloride, copper sulfate, magnesium sulfate, manganese sulfate, aluminum chloride, aluminum sulfate, polyaluminum chloride, and polyaluminum hydroxide. Inter alia, the metal salt is preferably a trivalent metal salt from the viewpoint that aggregation can be advanced with a smaller amount.

These metal salts may be used alone or in combination of two or more thereof.

### (5) the Step of Aging the Toner Base Particles by Thermal Energy to Control the Shape of the Toner Base Particles

This step is performed as necessary in a case where the toner base particles are aged by thermal energy to control the shape thereof.

Specifically, in the aging treatment, a dispersion of the toner base particles is heated and stirred by adjusting the heating temperature, the stirring speed, the heating time, and the like such that the circularity of the toner base particles becomes a desired value.

### (6) the Step of Cooling the Dispersion of Toner Base Particles

In this step, cooling processing of the dispersion of toner base particle is performed. The cooling speed is preferably within a range of 1° C./min to 20° C./min. The specific method of the cooling processing is not particularly limited. Examples thereof include a method of performing cooling by introducing a refrigerant from the outside of a reaction vessel, a method of performing cooling by directly charging cold water into the reaction system, and a method of performing cooling by a heat exchanger.

(7) the Step of Separating the Toner Base Particles from the Aqueous Medium by Filtration and Washing the Toner Base Particles to Remove the Surfactant and the Like Therefrom to Obtain Wet Toner Base Particles

In this step, the toner base particles are subjected to solid-liquid separation from the cooled dispersion of toner base particles. Then, the obtained toner cake is washed to remove adhered substances such as the surfactant and the coagulant, thereby obtaining wet toner base particles. Note that, the “toner cake” herein refers to an aggregation of wet toner base particles aggregated in a cake shape.

The method of solid-liquid separation is not particularly limited, and examples thereof include a centrifugation method, a vacuum filtration method performed using a Nutsche filter or the like, and a filtration method performed using a filter press or the like. In addition, in the washing, water washing is preferably performed until the electric conductivity of the filtrate becomes equal to or less than 10 μS/cm.

### (8) the Step of Performing Solvent Removal for the Wet Toner Base Particles

This step is performed as necessary in a case where the amount of the solvent contained in the wet toner base particles is reduced.

By performing the solvent removal processing, the amount of the solvent contained in the obtained wet toner base particles can be reduced. In addition, the amount of the solvent contained in the obtained wet toner base particles can be adjusted by adjusting the time, rotation conditions, pressurization conditions, and the like in the solvent removal processing.

(9) the Step of Drying the Wet Toner Base Particles with an Airflow in a Dryer

In this step, the wet toner base particles that have been subjected to the washing processing and, in some cases, further subjected to the solvent removal processing are dried with a dryer.

Examples of the dryer include a spray dryer, a vacuum freeze dryer, and a reduced pressure dryer. In particular, it is preferable to use a stationary shelf dryer, a movable shelf dryer, a fluidized bed dryer, a rotary dryer, a stirring dryer, or the like as the dryer.

The water content of the dried toner base particles is preferably equal to or less than 5% by mass, and more preferably equal to or less than 2% by mass.

Note that, in a case where the dried toner base particles are aggregated with by a weak inter-particle attractive force, the aggregate may also be subjected to crushing processing. As a crushing processing apparatus, a mechanical crushing apparatus such as a jet mill, a Henschel mixer, a coffee mill, or a food processor can be used.

In addition, as the drying temperature, the drying is preferably performed at a temperature within a range of 10° C. to 45° C., and particularly preferably performed at a temperature within a range of 20° C. to 40° C. When the drying is performed at, as the drying temperature, a temperature higher than 45° C., it is considered that the crystalline component in the toner is brought into a molten state and the structure control becomes difficult.

### (10) the Step of Adding an External Additive to the Dried Toner Base Particles

The toner base particles can be used as toner as they are, but an external additive such as a so-called fluidizing agent or a cleaning aid may also be added to the toner base particles from the viewpoint of fluidity, chargeability, cleaning property, and the like.

Examples of a mixing apparatus for the external additive include a mechanical mixing apparatus such as a Henschel mixer and a coffee mill.

The steps (1) to (10) described above are an example of the method of producing the toner containing toner base particles, and the present invention is not limited thereto.

The toner base particles contained in the toner according to the present invention may have a core-shell structure. Due to the toner base particles having a shell layer, both low-temperature fixability and heat resistance can be achieved. In a case where a shell layer is formed, the shell layer is preferably formed after core particles are formed in the step (4). Note that, the shell layer is preferably formed of an amorphous resin. The method for forming the shell layer is not particularly limited, and a conventional method known in the art can be used.

### [Physical Properties of Toner]

### <Volume Average Particle Diameter of Toner Particles>

The toner particles preferably have a volume average particle diameter of 3.0 μm to 6.5 μm. In light of ease of production, the toner particles preferably have a volume average particle size equal to or greater than 3.0 μm. In addition, the toner particles preferably has a volume average particle diameter equal to or less than 6.5 μm from the viewpoint that an image defect due to a low charge amount component can be made less likely to occur without excessively lowering the charge amount.

The “volume average particle diameter” of the toner particles described in the present invention is a volume-based median diameter (D50). The volume-based median diameter can be measured and calculated using, for example, an apparatus in which a computer system for data processing is connected to “Multisizer 3 (manufactured by Beckman Coulter, Inc)”.

As a measurement procedure, 0.02 g of toner particles are dispersed in 20 ml of a surfactant solution. The surfactant solution is, for example, a solution obtained by diluting a neutral detergent containing a surfactant component with pure water by 10 times for the purpose of dispersing the toner particles. Thereafter, ultrasound dispersion is performed for one minute to prepare a toner particle dispersion. This toner particle dispersion is injected with a pipette into a beaker containing ISOTON II (manufactured by Beckman Coulter, Inc) in a sample stand until the concentration to be measured reaches 5% to 10%, and the count of the measuring machine is set to 25000 for measurement.

Note that, Multisizer 3 used has an aperture diameter of 100 μm. The measurement range of 1 μm to 30 μm is divided into 256 measurement ranges, the frequency is calculated, and the particle size at which the volume cumulative fraction is 50% from the largest is defined as the volume-based median diameter (D50).

The volume average particle diameter of the toner particles can be controlled, for example, by controlling the concentration of the coagulant, the addition amount of the organic solvent, the fusion time, or the like at the time of production.

### <Average Circularity of Toner Particles>

The average circularity of the toner particles is preferably equal to or greater than 0.945 because a shape closer to a spherical shape is better from the viewpoint of charging and fluidity.

The method of calculating the average circularity is as follows.

The toner particles are wetted with an aqueous surfactant solution and dispersed by ultrasound dispersion for one minute. Thereafter, using a flow-type particle image analyzer “FPIA-3000” (manufactured by Sysmex Corporation), measurement is performed at an appropriate concentration with an HPF (high magnification imaging) detection number of 3000 to 10000 under measurement conditions of an HPF mode. Within this range, a reproducible measurement value can be obtained. The circularity is calculated by the following formula.

Circularity=(perimeter of a circle having the same projected area as a particle image)/(perimeter of a particle projection image)

The average circularity is an arithmetic average value obtained by adding up the circularities of the respective particles and dividing the sum by the total number of the measured particles.

### [Developer]

The toner can be used as a magnetic or non-magnetic mono-component developer. In addition, the toner may be mixed with a carrier to prepare a two-component developer.

In a case where the toner is used as a two-component electrostatic charge image developer, magnetic particles made of a conventional material known in the art, such as a metal such as iron, ferrite, or magnetite, or an alloy of such a metal and a metal such as aluminum or lead can be used as a carrier. In particular, ferrite particles are preferable as the carrier.

As the carrier, a coated carrier in which the surface of magnetic particles is coated with a coating agent such as a resin, a dispersion-type carrier in which magnetic fine powders are dispersed in a binder resin, or the like may be used.

The volume-based median diameter (D50) of the carrier is preferably within a range of 20 μm to 100 μm, and more preferably within a range of 25 μm to 80 μm.

The volume-based median diameter (D50) of the carrier can be measured with, for example, a laser diffraction particle size distribution analyzer HELOS (manufactured by SYMPATEC GmbH) equipped with a wet disperser.

### [Image Forming Method]

Hereinafter, an example of an electrophotographic image forming method using the above-described toner will be described, but the present invention is not limited to this image forming method.

The electrophotographic method includes: a latent image forming step; a step of developing based on a latent image by using the above-described toner; a step of transferring the toner onto a recording medium; and a step of fixing the transferred toner onto the recording medium. In addition, the image forming method may further include a step of applying varnish to the surface of a toner image formed by fixing the toner to form a varnish coat. The formation of the varnish coat improves image quality and durability.

### EXAMPLES

Hereinafter, the present invention will be specifically described with reference to Examples, but the present invention is not limited thereto. Note that, in the following Examples, operations were performed at room temperature (25° C.), unless otherwise specified. In addition, unless otherwise specified, “%” and “part(s)” mean “% by mass” and “part(s) by mass”, respectively.

### <Preparation of Styrene-Acrylic Resin Particle Dispersion 1>

### (1) First Stage Polymerization

A reaction vessel equipped with a stirrer, a temperature sensor, a cooling pipe, and a nitrogen inlet apparatus was prepared. Into the reaction vessel, 8 parts by mass of sodium dodecyl sulfate and 3000 parts by mass of ion-exchanged water were charged and dissolved to prepare a surfactant solution. The internal temperature was raised to 80° C. while the surfactant solution was stirred at a stirring speed of 230 rpm under a nitrogen stream. After the temperature increase, a solution prepared by dissolving 10 parts by mass of potassium persulfate (KPS) in 200 parts by mass of ion-exchanged water was added to the surfactant solution. After the liquid temperature was caused to be 80° C. again, a polymerizable monomer mixed liquid containing the following compounds was added dropwise over one hour.

| | | |
|---|---|---|
| Styrene | 480 | parts by mass |
| n-Butyl acrylate | 250 | parts by mass |
| Methacrylic acid | 68 | parts by mass |
| n-Octyl-3-mercaptopropionate | 16 | parts by mass |

After the dropwise addition, the system was heated and stirred at 80° C. for two hours to perform polymerization (first stage polymerization), thereby preparing a “resin particle dispersion 1 h” containing “resin particles 1 h”.

### (2) Second Stage Polymerization

In a flask equipped with a stirrer, a surfactant solution containing 7 parts by mass of sodium polyoxyethylene-2-dodecyl ether sulfate dissolved in 800 parts by mass of ion-exchanged water was heated to 98° C. To the surfactant dispersion, 260 parts by mass of the “resin particle dispersion 1 h” in terms of solid component and a polymerizable monomer mixed liquid containing the following compounds were added.

| | | |
|---|---|---|
| Styrene | 245 | parts by mass |
| n-Butyl acrylate | 120 | parts by mass |
| n-Octyl-3-mercaptopropionate | 1.5 | parts by mass |
| Paraffin wax “HNP-11 (manufactured by | 525 | parts by mass |
| Nippon Seiro Co., Ltd)” | | |

After the addition of the polymerizable monomer mixed liquid, a dispersion containing emulsified particles was prepared by performing mixing and dispersing processing for one hour using a mechanical disperser “CLEARMIX” (manufactured by M Technique Co., Ltd) including a circulation path.

Subsequently, a solution prepared by dissolving 6 parts by mass of potassium persulfate in 200 parts by mass of ion-exchanged water was added to the dispersion. Then, the system composed of the dispersion and the added solution was heated and stirred at 82° C. for one hour to perform polymerization (second stage polymerization), thereby producing a “resin particle dispersion IHM” containing “resin particles 1HM”.

### (3) Third Stage Polymerization

An initiator solution prepared by dissolving 11 parts by mass of potassium persulfate in 400 parts by mass of ion-exchanged water was added to the “resin particle dispersion IHM”, and the liquid temperature was set to 80° C. Thereafter, a polymerizable monomer mixed liquid containing the following compounds was added dropwise over one hour.

| | | |
|---|---|---|
| Styrene | 435 | parts by mass |
| n-Butyl acrylate | 130 | parts by mass |
| Methacrylic acid | 33 | parts by mass |
| n-Octyl-3-mercaptopropionate | 8 | parts by mass |

After the completion of the dropwise addition, the mixture was heated and stirred for two hours to perform polymerization (third stage polymerization), and then cooled to 28° C. to prepare a styrene-acrylic resin particle dispersion 1 containing styrene-acrylic resin particles.

When the particle size of the polymer particles contained in the styrene-acrylic resin particle dispersion 1 was measured using an electrophoretic light scattering spectrometer “ELS-800 (manufactured by Otsuka Electronics Co., Ltd)”, the volume-based median diameter was 150 nm. In addition, when the glass transition temperature was measured by a method known in the art, the glass transition temperature was 45° C. The styrene-acrylic resin constituting the styrene-acrylic resin particles had a weight-average molecular weight of 32000.

### <Preparation of Styrene-Acrylic Resin Particle Dispersions 2 to 10>

Styrene-acrylic resin particle dispersions 2 to 10 were prepared in the same manner as the styrene-acrylic resin particle dispersion 1, except that the amount of the paraffin wax to be added in the second stage polymerization in (2) above was changed as illustrated in the following Table 1.

TABLE 1

| | Paraffin wax |
|---|---|
| | content (parts |
| | by mass) |
| Styrene-acrylic resin particle dispersion 1 | 525 |
| Styrene-acrylic resin particle dispersion 2 | 408 |
| Styrene-acrylic resin particle dispersion 3 | 216 |
| Styrene-acrylic resin particle dispersion 4 | 228 |
| Styrene-acrylic resin particle dispersion 5 | 658 |
| Styrene-acrylic resin particle dispersion 6 | 774 |
| Styrene-acrylic resin particle dispersion 7 | 787 |
| Styrene-acrylic resin particle dispersion 8 | 387 |
| Styrene-acrylic resin particle dispersion 9 | 905 |
| Styrene-acrylic resin particle dispersion 10 | 0 |

### <Preparation of Mold Release Agent Fine Particle Dispersion>

As a mold release agent, 250 parts by mass of paraffin wax “HNP-11 (manufactured by Nippon Seiro Co., Ltd)” were heated to 95° C. to be dissolved. This was further charged into an aqueous surfactant solution in which sodium alkyl diphenyl ether disulfonate had been dissolved in 800 parts by mass of ion-exchanged water so as to have a concentration of 3% by mass, and then dispersion processing was performed using an ultrasound homogenizer. The solid content concentration was adjusted to 25% by mass. Thus, a mold release agent fine particle dispersion [1] in which mold release agent fine particles were dispersed in an aqueous medium was prepared.

When the volume-based median diameter of the mold release agent fine particles in the mold release agent fine particle dispersion was measured using a Microtrac particle size distribution analyzer “UPA-150” (manufactured by Nikkiso Co., Ltd), the volume-based median diameter was 190 nm.

### <Preparation of Coloring Agent Particle Dispersion>

While a solution obtained by dissolving 90 parts by mass of sodium dodecyl sulfate in 1600 parts by mass of ion-exchanged water was stirred, 420 parts by mass of C.I. Pigment Blue 15:3 (manufactured by Toyo Ink Industries, Ltd) was gradually added thereto.

Then, a stirring apparatus “CLEARMIX (manufactured by M Technique Co., Ltd)” was used to perform dispersion processing to prepare a coloring agent particle dispersion.

### <Preparation of Amorphous Polyester Particle Dispersion>

First, an amorphous polyester was produced, and then the produced amorphous polyester was dispersed in a liquid to prepare an amorphous polyester particle dispersion.

### (Production of Amorphous Polyester)

The following compounds were charged into a four-neck flask equipped with a nitrogen inlet pipe, a dewatering pipe, a stirrer, and a thermocouple, and subjected to a polycondensation reaction at 230° C. for eight hours.

| | | |
|---|---|---|
| Propylene oxide (2 mol) adduct of Bisphenol A | 285.7 | parts by mass |
| Terephthalic acid | 66.9 | parts by mass |
| Fumaric acid | 47.4 | parts by mass |
| Esterification catalyst (tin octylate) | 1.43 | parts by mass |

The polycondensation reaction for eight hours was followed by a reaction at 8 kPa for one hour and cooling to 160° C., and then a mixture of the following compounds was added dropwise through a dropping funnel over one hour.

| | | |
|---|---|---|
| Acrylic acid | 3.3 | parts by mass |
| Styrene | 26.4 | parts by mass |
| n-Butyl acrylate | 6.6 | parts by mass |
| Polymerization initiator (di-t-butyl peroxide) | 5.3 | parts by mass |

After the dropwise addition, an addition polymerization reaction was allowed to be continued for one hour while the temperature was kept at 160° C. Thereafter, the temperature was raised to 200° C., the pressure was kept at 10 kPa for one hour, and then styrene and butyl acrylate were removed to obtain an amorphous polyester.

### (Dispersion of Amorphous Polyester)

Methyl ethyl ketone and isopropyl alcohol were added to a reaction vessel equipped with an anchor blade that provides stirring power. Further, the amorphous polyester coarsely pulverized with a hammer mill was gradually added and stirred to be completely dissolved, thereby obtaining a polyester resin solution to be an oil phase. A small amount of a dilute aqueous ammonia solution was added dropwise to the stirred oil phase.

Then, the oil phase was added dropwise to ion-exchanged water to cause phase inversion emulsification, followed by solvent removal under reduced pressure by an evaporator. Amorphous polyester particles were dispersed in the reaction system, and ion-exchanged water was added to the dispersion to adjust the solid content to 20% by mass, thereby preparing an amorphous polyester particle dispersion.

When the volume-based median diameter of the amorphous polyester particles in the dispersion was measured using a particle size distribution analyzer “Nanotrack Wave (manufactured by MicrotracBEL Corp)”, the volume-based median diameter was 173 nm.

### <Preparation of Crystalline Polyester Particle Dispersion>

First, a crystalline polyester was produced, and then the produced crystalline polyester was dispersed in a liquid to prepare a crystalline polyester particle dispersion.

### (Production of Crystalline Polyester)

The following compounds were charged into a four-neck flask equipped with a nitrogen inlet pipe, a dewatering pipe, a stirrer, and a thermocouple, and were heated to 170° C. to be dissolved.

| | |
|---|---|
| Sebacic acid | 290 parts by mass |
| 1,12-dodecanediol | 292 parts by mass |

A mixture of the following compounds was added dropwise to the above dissolution solution through a dropping funnel over 90 minutes.

| | | |
|---|---|---|
| Acrylic acid | 2 | parts by mass |
| Styrene | 34 | parts by mass |
| n-Butyl acrylate | 12 | parts by mass |
| Polymerization initiator | 7 | parts by mass |

(di-t-butyl peroxide)

Then, after aging for 60 minutes, unreacted addition polymerization monomers were removed under reduced pressure (8 kPa). Note that, the amount of monomers removed at this time was extremely small with respect to the raw material monomer ratio of the resin described above. Thereafter, 0.8 parts by weight of Ti(OBu) 4 were charged, the temperature was raised to 235° C., and a reaction was conducted under atmospheric pressure (101.3 kPa) for five hours, and further under reduced pressure (8 kPa) for one hour.

Next, after cooling to 200° C., a reaction was allowed to be conducted under reduced pressure (20 kPa) for one hour to obtain a crystalline polyester. When the crystalline polyester was measured by DSC at 10° C./min, the crystalline polyester had a definite peak, and the temperature of the peak top was 77° C. The half-value width was 8° C.

### (Dispersion of Crystalline Polyester)

Methyl ethyl ketone and isopropyl alcohol were added to a reaction vessel equipped with an anchor blade that provides stirring power. Further, the crystalline polyester resin coarsely pulverized with a hammer mill was gradually added and stirred to be completely dissolved, thereby obtaining a polyester resin solution to be an oil phase. A small amount of a dilute aqueous ammonia solution was added dropwise to the stirred oil phase, and then the oil phase was added dropwise to ion-exchanged water to cause phase inversion emulsification, followed by solvent removal under reduced pressure by an evaporator. Crystalline polyester resin particles were dispersed in the reaction system, and ion-exchanged water was added to the dispersion to adjust the solid content to 20% by mass, thereby preparing a crystalline polyester resin particle dispersion.

When the volume-based median diameter of the particles in the dispersion was measured using a particle size distribution analyzer “Nanotrack Wave (manufactured by MicrotracBEL Corp)”, the volume-based median diameter was 173 nm.

### <Production of Toner Base Particles 1>

A reaction vessel equipped with a stirrer, a temperature sensor, a cooling pipe, and a nitrogen inlet apparatus was prepared. The reaction vessel was charged with the following compounds.

| | |
|---|---|
| Styrene-acrylic resin | 240 parts by mass (in |
| particle dispersion 1 | terms of solid content) |
| Amorphous polyester | 300 parts by mass (based |
| particle dispersion | on solid content) |
| Crystalline polyester | 60 parts by mass (in terms |
| particle dispersion | of solid content) |
| Ion-exchanged water | 1400 parts by mass |

### Coloring Agent Particle Dispersion 120 Parts by Mass (in Terms of Solid Content)

Further, a solution prepared by dissolving 3 parts by mass of polyoxyethylene-2-dodecyl sodium sulfate in 120 parts by mass of ion-exchanged water was added, and the liquid temperature was set to 30° C. Thereafter, a 5 mol/liter aqueous sodium hydroxide solution was added to adjust the pH to 10.

Then, an aqueous solution prepared by dissolving 35 parts by mass of magnesium chloride hexahydrate in 35 parts by mass of ion-exchanged water was added under stirring at 30° C. over ten minutes, the mixture was allowed to stand for three minutes, and then the temperature increase was started. The temperature was raised to 90° C. over 60 minutes, and the aggregation and fusion of particles described above were performed in a state in which the temperature was kept at 90° C. In this state, the particle diameter of the particles grown in the reaction vessel was measured using “Multisizer 3 (manufactured by Beckman Coulter, Inc)”. When the volume-based median diameter reached 6.5 μm, an aqueous solution prepared by dissolving 150 parts by mass of sodium chloride in 600 parts by mass of ion-exchanged water was added to stop the growth of the particles.

Further, as aging treatment, the liquid temperature was set to 98° C. and heating and stirring were performed to allow fusion of the particles to proceed until the average circularity measured by “FPIA-2100 (manufactured by Sysmex Corporation)” became 0.965.

Thereafter, the liquid temperature was cooled to 30° C., the pH of the liquid was adjusted to 2 using hydrochloric acid, and the stirring was stopped. Thus, a toner base particle dispersion 1 was prepared.

The toner base particle dispersion 1 produced through the above-described steps was subjected to solid-liquid separation with a basket-type centrifugal separator “MARKIII Model No. 60×40 (manufactured by Matsumoto Kikai Co., Ltd)” to form a wet cake of toner base particles 1. This wet cake was washed with ion-exchanged water at 45° C. in the basket-type centrifugal separator until the electrical conductivity of the filtrate became 5 μS/cm. Thereafter, the resultant was transferred to a “Flash Jet Dryer (manufactured by Seishin Enterprise Co., Ltd)” and subjected to drying processing until the water content became 0.5% by mass, thereby producing toner base particles 1 of cyan color.

### <Production of Toner Base Particles 2 to 14>

As illustrated in Table 2, the types and amounts of the dispersions to be added were changed. Toner base particles 2 to 14 were produced in the same manner as the toner base particles 1 except the above.

TABLE 2

| | Amorphous | Crystalline | | | Mold release |
|---|---|---|---|---|---|
| | polyester | polyester | Styrene-acrylic | | agent fine |
| | particle | particle | resin particle | | particle |
| Toner | dispersion | dispersion | dispersion | | dispersion |
| base | parts | parts | | parts | parts |
| particles | by mass | by mass | Type | by mass | by mass |
| 1 | 300 | 60 | 1 | 240 | — |
| 2 | 300 | 60 | 2 | 240 | — |
| 3 | 300 | 60 | 3 | 240 | — |
| 4 | 120 | 60 | 4 | 420 | — |
| 5 | 300 | 60 | 5 | 240 | — |
| 6 | 300 | 60 | 6 | 240 | — |
| 7 | 180 | 60 | 1 | 360 | — |
| 8 | 180 | 60 | 7 | 360 | — |
| 9 | 126 | 60 | 6 | 414 | — |
| 10 | 126 | — | 6 | 474 | — |
| 11 | 90 | 60 | 8 | 450 | — |
| 12 | 420 | 60 | 8 | 120 | — |
| 13 | 300 | 60 | 9 | 240 | — |
| 14 | 300 | 60 | 10 | 168 | 72 |

### <Production of External Additive: Silica Particles>

An Erlenmeyer flask was charged with 347.4 g of pure water that had been weighed, 110 g of tetramethoxysilane (TMOS) were added to the Erlenmeyer flask under stirring, and the mixture was stirred as it was for one hour to prepare 457.4 g of a TMOS hydrolysis liquid.

Next, a three-liter reaction vessel equipped with a stirrer, a dropping funnel, and a thermometer was charged with 2250 g of water and 112 g of ethylene diamine, and mixing was performed. This solution was adjusted such that the temperature of the solution became 35° C., and the TMOS hydrolysis liquid was added thereto at 5.0 mL/min while stirring.

After the completion of the addition of the TMOS hydrolysis liquid, this state was allowed to stand for 30 minutes, and then 4.5 g of a 1 mmol/g aqueous solution of ethylenediamine were added thereto to adjust the pH level to 8 to 9.

Thereafter, while appropriately adding the alkaline catalyst (1 mmol/g aqueous solution of ethylenediamine) so as to maintain pH 8, the remaining TMOS hydrolysis liquid was added at 5.0 mL/min every three hours, and this operation was continued. In total, 457.4 g thereof were added.

After the completion of the dropwise addition of the TMOS hydrolysis liquid, the stirring was further continued for 0.5 hours to perform hydrolysis and condensation, thereby obtaining a mixed medium dispersion of hydrophilic spherical silica particles. The number-based median diameter of the obtained silica particles was 80 nm.

### (Hydrophobic Treatment)

A solution was prepared by mixing 20 parts by mass of hexamethyldisilazane (HMDS) with 50 parts by mass of ethanol. The silica particles having a median diameter of 80 nm obtained above were sprayed by spray drying to perform a hydrophobic treatment of the silica particles. After ethanol was removed by drying at 80° C., a hexamethyldisilazane (HMDS) treatment was performed while stirring at 250° C. for two hours to obtain silica particles. The median diameter of the silica particles after the hydrophobic treatment was 80 nm. The median diameter of the silica particles was unchanged before and after the hydrophobic treatment.

### <Production of Toner Particles 1 to 14>

### (External Addition Processing)

Each of the toner base particles 1 to 14 and silica particles were mixed with a Henschel mixer (FM-75 type, manufactured by Mitsui Miike Machinery Co., Ltd) at a rotational speed of 30 s−1 for a rotational time of 10 min to obtain each of toner particles 1 to 14.

| | | |
|---|---|---|
| Toner base particles | 1100 | parts by mass |
| Silica particles | 10.15 | parts by mass |

### <Production of Two-Component Developer>

A horizontal impeller type high-speed stirring apparatus was charged with 100 parts by mass of ferrite particles (volume-based median diameter: 50 μm (manufactured by Powdertech Co., Ltd)) and 4 parts by mass of a methyl methacrylate-cyclohexyl methacrylate copolymer resin (volume-based median diameter of primary particles: 85 nm) and mixing was performed for 15 minutes under conditions of a peripheral speed of the stirring impeller of 8 m/s and a temperature of 30° C. Then, the temperature was raised to 120° C. and stirring was continued for four hours. Thereafter, the mixture was cooled, and broken pieces of the methyl methacrylate-cyclohexyl methacrylate copolymer resin were removed with a 200-mesh sieve to prepare a resin-coated carrier.

The resin-coated carrier was mixed with each of the toner particles 1 to 14 such that the concentration of the toner was 7% by mass with respect to the total mass of the toner and the carrier, and each of the toners 1 to 14 was used as a two-component developer.

### [Evaluation]

### (Low-Temperature Fixability)

As an image forming apparatus, a commercially available full-color multi-function machine “AccurioPress C3080 (manufactured by Konica Minolta, Inc)”, which was modified such that the surface temperatures of a fixing upper belt and a fixing lower roller can be changed, was used, and each toner as the above-described two-component developer was loaded.

A test in which a solid image having a toner adhesion amount of 11.3 g/m² was output on A4 (basis weight: 90 g/m²) plain paper at a fixing temperature of 100° C. to 200° C. was repeatedly performed while changing the fixing temperature in increments of 5° C.

The fixing temperature that was the lowest among those at which no image contamination due to fixing offset was visually observed was defined as the lowest fixing temperature, and the low-temperature fixability was evaluated according to the following evaluation criteria.
⊚: The lowest fixing temperature was lower than 135° C. (the low-temperature fixability of the toner is extremely good).
◯: The lowest fixing temperature was equal to or higher than 135° C. and less than 145° C. (the low-temperature fixability of the toner is good).
Δ: The lowest fixing temperature was equal to or higher than 145° C. and less than 155° C. (the low-temperature fixability of the toner is good).
x: The lowest fixing temperature was equal to or higher than 155° C. (the low-temperature fixability of the toner was poor, and it was unusable).

### (Separability)

As an image forming apparatus, a commercially available color multi-function machine AccurioPress C3080 (manufactured by Konica Minolta, Inc), which was modified such that the surface temperatures of a fixing upper belt and a fixing lower roller can be changed, was used, and the two-component developers of the respective colors described above were sequentially loaded. The above-described apparatus was modified such that the fixing temperature, the toner adhesion amount, and the system speed could be freely set.

OK Top Coat+85 g/m² (manufactured by Oji Paper Co., Ltd) was used as evaluation paper. The temperature (U. O. avoidance temperature+25° C.) raised by 25° C. from the temperature as a reference at which under-offset does not occur (U. O. avoidance temperature) was defined as the temperature of the upper fixing belt, the lower fixing roller was set to 90° C., and each entirely solid image (adhesion amount: 8.0 g/m²) was output by varying the leading edge margin amount. The leading edge margin amount immediately before paper jam occurred was defined as the scale of the thin paper separability. The smaller the value of the separable leading edge margin amount, the better the separation performance. Note that, the evaluation was performed in a normal temperature and normal humidity environment (NN environment: 25° C. and 50% RH). In addition, the separable leading edge margin means that the smaller the separable leading edge margin is, the more excellent the thin paper separability is.
⊚: The value of the separable leading edge margin amount was equal to or greater than 0 mm and equal to or less than 2 mm.
◯: The value of the separable leading edge margin amount was greater than 2 mm and equal to or less than 4 mm.
Δ: The value of the separable leading edge margin amount was greater than 4 mm and equal to or less than 6 mm.
x: The value of the separable leading edge margin amount was greater than 6 mm.

### (Varnish Test)

In a commercially available color multi-function machine AccurioPress C3080 (manufactured by Konica Minolta, Inc), coated paper of 157 g/m² was selected as the paper type, the respective developers were sequentially loaded, and a solid image having a toner adhesion amount of 8.0 g/m² was formed on A4 (basis weight: 157 g/m²) gloss coated sheet and fixing processing was performed under the normal temperature and normal humidity (temperature of 20° C. and relative humidity of 50%) environment.

Using a varnish coater (Digi UV Coater manufactured by BN Technologies), coating conditions were set such that the speed was 30 m/min and the coating thickness was about 5 μm, and UV-clear manufactured by SAKATA INX CORPORATION was used as the varnish to form a varnish layer, thereby producing an image.

### (Varnish Adhesion)

A cellophane tape (CT-12, manufactured by Nichiban Co., Ltd) was attached to the varnish on the solid image applied by the above method. The cellophane tape was peeled off to evaluate the vanish adhesion. The evaluation criteria were as follows. “, and” were determined to have no quality problem.
⊚: No peeling of varnish
◯: Peeling of less than 10% with respect to the bonded area of the cellophane tape
Δ: Peeling of equal to or greater than 10% and less than 20% of the bonded area of the cellophane tape
x: Peeling of equal to or greater than 20% with respect to the bonded area of the cellophane tape

### (Varnish Applicability)

The varnish layer of each of the obtained evaluation images was visually observed, and the wettability of the varnish was evaluated according to the following evaluation criteria.
⊚: Zero pinhole having a size of 0.1 mm in a corner of 10 cm×10 cm
◯: Not more than two pinholes having a size of 0.1 mm in the corner of 10 cm×10 cm
Δ: Not more than three to ten pinholes having a size of 0.1 mm in the corner of 10 cm×10 cm
ΔΔ: There are not more than eleven pinholes having a size of 0.1 mm or there is/are a pinhole(s) having a size of not less than 0.1 mm in the corner of 10 cm×10 cm

The composition of each toner and the evaluation results are indicated in Table 3 below. The toner also includes a coloring agent. However, in Table 3, the total of the vinyl resin, the amorphous polyester resin, the crystalline polyester resin, and the mold release agent particles contained in the toner excluding the coloring agent was set to 100% by mass.

TABLE 3

| | | Toner base particles | | | | |
|---|---|---|---|---|---|---|
| | | (excluding coloring agent) | | | | |
| | | Binding resin | | | | |
| | | Polyester resin | | | | Mold release agent with respect |
| | | Amorphous | Crystalline polyester | | | to the total mass of vinyl resin |
| | | polyester resin | resin | Vinyl resin | Mold release agent | and mold release agent |
| | | (% by mass) | (% by mass) | (% by mass) | (% by mass) | (% by mass) |
| Ex. 1 | Toner 1 | 50 | 10 | 28 | 12.0 | 30 |
| Ex. 2 | Toner 2 | 50 | 10 | 30 | 10.0 | 25 |
| Ex. 3 | Toner 3 | 50 | 10 | 34 | 6.0 | 15 |
| Ex. 4 | Toner 4 | 20 | 10 | 59 | 11.0 | 16 |
| Ex. 5 | Toner 5 | 50 | 10 | 26 | 14.0 | 35 |
| Ex. 6 | Toner 6 | 50 | 10 | 25 | 15.5 | 39 |
| Ex. 7 | Toner 7 | 30 | 10 | 42 | 18.0 | 30 |
| Ex. 8 | Toner 8 | 30 | 10 | 37 | 23.5 | 39 |
| Ex. 9 | Toner 9 | 21 | 10 | 43 | 26.5 | 38 |
| Ex. 10 | Toner 10 | 21 | 0 | 49 | 30.5 | 39 |
| Com. Ex. 1 | Toner 11 | 15 | 10 | 57 | 18.0 | 24 |
| Com. Ex. 2 | Toner 12 | 69 | 11 | 15 | 4.8 | 24 |
| Com. Ex. 3 | Toner 13 | 50 | 10 | 23 | 17.0 | 42 |
| Com. Ex. 4 | Toner 14 | 50 | 10 | 28 | 12.0 | 0 |

| | | Low-temperature | | Varnish | Varnish |
|---|---|---|---|---|---|
| | | fixability | Separability | adhesion | applicability |
| Ex. 1 | Toner 1 | ⊚ | ⊚ | ⊚ | ⊚ |
| Ex. 2 | Toner 2 | ⊚ | ◯ | ⊚ | ⊚ |
| Ex. 3 | Toner 3 | ⊚ | Δ | ◯ | ⊚ |
| Ex. 4 | Toner 4 | Δ | ⊚ | ⊚ | ⊚ |
| Ex. 5 | Toner 5 | ⊚ | ⊚ | ◯ | ⊚ |
| Ex. 6 | Toner 6 | ⊚ | ⊚ | Δ | ⊚ |
| Ex. 7 | Toner 7 | ◯ | ⊚ | ⊚ | ⊚ |
| Ex. 8 | Toner 8 | ◯ | ⊚ | Δ | ◯ |
| Ex. 9 | Toner 9 | Δ | ⊚ | Δ | Δ |
| Ex. 10 | Toner 10 | Δ | ⊚ | Δ | ΔΔ |
| Com. Ex. 1 | Toner 11 | X | ⊚ | X | ◯ |
| Com. Ex. 2 | Toner 12 | ⊚ | X | ⊚ | ⊚ |
| Com. Ex. 3 | Toner 13 | ⊚ | ⊚ | X | ⊚ |
| Com. Ex. 4 | Toner 14 | ⊚ | ⊚ | X | ⊚ |

As can be seen from Examples and Comparative Example 1, when the amount of the amorphous polyester resin was equal to or greater than 20% by mass, the low-temperature fixability was good. In addition, the varnish adhesion was also good. It is assumed that this is because, since the amount of the amorphous polyester resin is large, the mold release agents do not coalesce with each other at the time of fixing the toner, and the mold release agents can be smeared on the surface of the image while maintaining the finely dispersed state.

As can be seen from Examples and Comparative Example 2, when the amount of the mold release agent was equal to or greater than 5% by mass with respect to the total mass of the binding resin and the mold release agent, the separability was good.

As can be seen from Examples and Comparative Example 3, when the amount of the mold release agent was equal to or less than 40% by mass with respect to the total mass of the vinyl resin and the mold release agent, the varnish adhesion was good.

As can be seen from Examples and Comparative Example 4, when the mold release agent was encapsulated in the vinyl resin, the varnish adhesion was good. It is presumed that this is because the mold release agent is present in a finely dispersed state in the vinyl resin.

### INDUSTRIAL APPLICABILITY

The toner of the present invention is useful for forming an image having good low-temperature fixability and separability.

Although embodiments of the present invention have been described in detail, the disclosed embodiments are made for purposes of example only and not limitation. The scope of the present invention should be interpreted by terms of the appended claims.

What is claimed is:

1. Toner, comprising a binding resin and a mold release agent, wherein:
the binding resin contains a vinyl resin and an amorphous polyester resin,
an amount of the amorphous polyester resin is equal to or greater than 20% by mass with respect to a total mass of the binding resin and the mold release agent,
an amount of the mold release agent is equal to or greater than 5% by mass with respect to the total mass of the binding resin and the mold release agent,
the mold release agent is encapsulated in the vinyl resin, and
the amount of the mold release agent is equal to or less than 40% by mass with respect to a total mass of the vinyl resin and the mold release agent.

2. The toner according to claim 1, wherein
the amount of the mold release agent is equal to or less than 30% by mass with respect to the total mass of the binding resin and the mold release agent.

3. The toner according to claim 1, wherein:
the amount of the amorphous polyester resin is equal to or greater than 25% by mass with respect to the total mass of the binding resin and the mold release agent, and
the amount of the mold release agent is equal to or less than 20% by mass with respect to the total mass of the binding resin and the mold release agent.

4. The toner according to claim 1, wherein:
the amount of the amorphous polyester resin is equal to or greater than 40% by mass with respect to the total mass of the binding resin and the mold release agent, and
the amount of the mold release agent is equal to or less than 15% by mass with respect to the total mass of the binding resin and the mold release agent.

5. The toner according to claim 1, wherein the vinyl resin is a styrene-acrylic resin.

6. The toner according to claim 1, wherein the toner contains a coloring agent.

7. A method of producing the toner according to claim 1.

8. An image forming method using the toner according to claim 1.
